(19) United States
(12) Patent Application Publication
(10) Pub. No.: US 2023/0257957 A1
(43) Pub. Date: Aug. 17, 2023

(54) UTILITY COVER AND LIGHTWEIGHT UNDERGROUND ENCLOSURE MADE WITH LONG FIBER COMPOSITE MATERIAL AND METHOD OF MANUFACTURING THEREOF

(71) Applicant: Hubbell Incorporated, Shelton, CT (US)

(72) Inventors: Nejib Masghouni, Alpharetta, GA (US); Cauley Sean Price, Aiken, SC (US); Scott Venczel, Farragut, TN (US)

(73) Assignee: Hubbell Incorporated, Shelton, CT (US)

(21) Appl. No.: 18/168,112

(22) Filed: Feb. 13, 2023

Related U.S. Application Data
(60) Provisional application No. 63/309,854, filed on Feb. 14, 2022.
(60) Provisional application No. 63/410,774, filed on Sep. 28, 2022.

(51) Int. Cl. E02D 29/14; B29C 45/00; B29C 43/00

(52) U.S. Cl. CPC E02D 29/1472; B29C 45/0005; B29C 43/003; B29C 45/0001; B29C 43/006; B29L 2031/3481

(57) ABSTRACT

A lightweight composite utility cover includes an upper surface formed of a long fiber thermoplastic composite structure. An underground enclosure also includes a side wall formed of a long fiber reinforced thermoplastic material. A method of making an underground enclosure also includes Long Fiber thermoplastic (LFT) injection and/or compression molding a side wall of the underground enclosure.

### CROSS REFERENCE TO RELATED APPLICATIONS

This application claims the benefit of U.S. Application 63/309,854 filed Feb. 14, 2022 and U.S. Application 63/410,774 filed Sep. 28, 2022, the contents of which are incorporated by reference herein.

### BACKGROUND

### 1. Field of the Invention

The present disclosure is related to a lightweight composite utility cover. In particular, the present disclosure is related to a lightweight cover for an underground utility enclosure made with long fiber thermoplastic composite material and the method of manufacturing of the cover. The present disclosure is also related to underground utility enclosures. In particular, the present disclosure is also related to a lightweight underground enclosure made with long fiber thermoplastic composite material and method of manufacturing thereof.

### 2. Description of Related Art

Underground utility covers are used to enclose cables, gas piping, and other electrical equipment. Traditionally the lids or covers used with utility enclosures are made of polymer concrete or resin reinforced material. While polymer concrete covers satisfy the structural requirements, they are too heavy to be carried by a single operator. On the other side, current resin reinforced materials are light but expensive. Besides, both materials have high VOC emissions and are non-recyclable.

Underground enclosures are used to enclose cables, gas piping, and other electrical equipment. Traditionally the utility manholes or underground enclosures are made of polymer concrete, concrete, cast-iron, or steel. While the current boxes of the underground enclosures satisfy the structural requirements, they are too heavy, and their production method is slow-paced. In addition, these materials are non-recyclable and cause high VOC emissions, especially polymer concrete.

Accordingly, it has been determined by the present disclosure that there is a continuing need for a cover and/or an underground enclosure that overcomes, alleviates, and/or mitigates one or more of the aforementioned and other deleterious effects of prior devices.

### SUMMARY

A lightweight composite utility cover is provided that has an upper surface formed of a long fiber thermoplastic composite structure.

A method of making a utility cover is also provided that has Long Fiber thermoplastic (LFT) injection and/or compression molding of an upper surface of the utility cover.

In some embodiments either alone or together with any one or more of the aforementioned and/or after-mentioned embodiments, the long fiber reinforced thermoplastic composite structure has a plurality of reinforcing fibers selected from the group consisting of glass, carbon, basalt, aramid, and a combination thereof.

In some embodiments either alone or together with any one or more of the aforementioned and/or after-mentioned embodiments, the long fiber reinforced thermoplastic composite has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

In some embodiments either alone or together with any one or more of the aforementioned and/or after-mentioned embodiments, the upper surface is formed by a first face sheet, and further comprises reinforcing ribs connected to the first face sheet.

In some embodiments either alone or together with any one or more of the aforementioned and/or after-mentioned embodiments, the first face sheet is a flat planar shape having a first length, first width and a first thickness.

In some embodiments either alone or together with any one or more of the aforementioned and/or after-mentioned embodiments, the upper surface has a pattern of bosses.

In some embodiments either alone or together with any one or more of the aforementioned and/or after-mentioned embodiments, the utility cover has a lower surface that is disposed generally opposite of the upper surface, and further comprises one or more reinforcement members coupled to the lower surface.

In some embodiments either alone or together with any one or more of the aforementioned and/or after-mentioned embodiments, a first slot and a second slot are disposed on the upper surface, and the first slot extends into a first reinforcement member of the one or more reinforcement members and the second slot extends into a second reinforcement member of the one or more reinforcement members aligned with the first reinforcement member, and the utility cover is configured to be lifted by the first slot and the second slot.

In some embodiments either alone or together with any one or more of the aforementioned and/or after-mentioned embodiments, the LFT injection and/or compression molding step forms a long fiber reinforced thermoplastic composite that has a plurality of reinforcing fibers selected from the group consisting of glass, carbon, basalt, aramid, and a combination thereof.

In some embodiments either alone or together with any one or more of the aforementioned and/or after-mentioned embodiments, the method includes the long fiber reinforced thermoplastic composite that has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

In some embodiments either alone or together with any one or more of the aforementioned and/or after-mentioned embodiments, the LFT injection and/or compression molding step further comprises LFT injection molding a pattern of bosses on an upper surface, a first slot and a second slot on the upper surface and a lower surface being opposite the upper surface and a first reinforcement member coupled to the lower surface, wherein the first slot extends into the first reinforcement member, wherein the lower surface is coupled to a second reinforcement member that is aligned with the first reinforcement member, wherein the second slot extends into the second reinforcement member, and wherein the cover is configured to be lifted by the first slot and the second slot.

An underground enclosure is also provided that includes a side wall formed of a long fiber reinforced thermoplastic material.

A method of making an underground enclosure is also provided that includes Long Fiber thermoplastic (LFT) injection and/or compression molding a side wall of the underground enclosure.

In some embodiments either alone or together with any one or more of the aforementioned and/or after-mentioned embodiments, the long fiber reinforced thermoplastic material has a plurality of reinforcing fibers selected from the group consisting of glass, carbon, basalt, aramid, and a combination thereof.

In some embodiments either alone or together with any one or more of the aforementioned and/or after-mentioned embodiments, the long fiber reinforced thermoplastic material has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

In some embodiments either alone or together with any one or more of the aforementioned and/or after-mentioned embodiments, the side wall is molded through a process selected from the group consisting of injection molding, compression, and fiber-direct compounding and molding process.

In some embodiments either alone or together with any one or more of the aforementioned and/or after-mentioned embodiments, the side wall is recyclable.

In some embodiments either alone or together with any one or more of the aforementioned and/or after-mentioned embodiments, the long fiber reinforced thermoplastic material combines chopped fibers with a resin melt to form a compounded mixture to inject the compounded mixture into a closed mold.

In some embodiments either alone or together with any one or more of the aforementioned and/or after-mentioned embodiments, the side wall is four side walls connected to a lower surface to surround an interior volume.

In some embodiments either alone or together with any one or more of the aforementioned and/or after-mentioned embodiments, a ridge extends outward and upward from each of the four side walls.

In some embodiments either alone or together with any one or more of the aforementioned and/or after-mentioned embodiments, the side wall has a rib.

In some embodiments either alone or together with any one or more of the aforementioned and/or after-mentioned embodiments, the side wall has at least one opening to receive a cover bolt.

In some embodiments either alone or together with any one or more of the aforementioned and/or after-mentioned embodiments, the side wall forms a circular, elliptical, or hexagonal shape.

In some embodiments either alone or together with any one or more of the aforementioned and/or after-mentioned embodiments, the side wall has an opening for water drainage.

In some embodiments either alone or together with any one or more of the aforementioned and/or after-mentioned embodiments, the side wall is connected to a lower surface that has an opening for water drainage.

In some embodiments either alone or together with any one or more of the aforementioned and/or after-mentioned embodiments, the side wall comprises materials that are polymers or thermoplastics and not thermoset materials.

In some embodiments either alone or together with any one or more of the aforementioned and/or after-mentioned embodiments, the LFT injection and/or compression molding step forms a long fiber reinforced thermoplastic material that has a plurality of reinforcing fibers selected from the group consisting of glass, carbon, basalt, aramid, and a combination thereof.

In some embodiments either alone or together with any one or more of the aforementioned and/or after-mentioned embodiments, the long fiber reinforced thermoplastic material has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

In some embodiments either alone or together with any one or more of the aforementioned and/or after-mentioned embodiments, the Long Fiber thermoplastic (LFT) injection and/or compression molding uses materials that are separate components that are then combined while forming the finished product of the underground enclosure.

In some embodiments either alone or together with any one or more of the aforementioned and/or after-mentioned embodiments, the Long Fiber thermoplastic (LFT) injection and/or compression molding can use closed molding so that workers are not exposed to harmful substances.

In some embodiments either alone or together with any one or more of the aforementioned and/or after-mentioned embodiments, the Long Fiber thermoplastic (LFT) injection and/or compression molding is an automated process so that desirably less people are touching parts.

The above-described and other features and advantages of the present disclosure will be appreciated and understood by those skilled in the art from the following detailed description, drawings, and appended claims.

### DESCRIPTION OF THE DRAWINGS

FIG. 1 is a top perspective view of a cover used with utility enclosures or underground enclosures.

FIG. 2 is a schematic diagram of a method of making a long fiber composite utility cover.

FIG. 3 is a perspective view of a cover for an underground enclosure.

FIG. 4 is a top view of the cover of FIG. 3, illustrating a first pattern.

FIG. 5 is a top view of the cover of FIG. 3, illustrating a second pattern.

FIG. 6 is a bottom view of the cover of FIG. 3.

FIG. 7 is a cross-sectional view of the cover of FIG. 3, viewed along line 5-5.

FIG. 8 is a perspective view of a cover according to another embodiment.

FIG. 9 is a bottom view of the cover of FIG. 8.

FIG. 10 is a cross-sectional view of the cover of FIG. 8, viewed along line 8-8.

FIG. 11 is a perspective view of a cover according to another embodiment.

FIG. 12 is a bottom view of the cover of FIG. 11.

FIG. 13 is a cross-sectional view of the cover of FIG. 11, viewed along line 11-11.

FIG. 14 is a perspective view of a cover according to another embodiment.

FIG. 15 is a bottom view of the cover of FIG. 14.

FIG. 15A is a bottom view of the cover of FIG. 14 modified to include tape.

FIG. 16 is a cross-sectional view of the cover of FIG. 14, viewed along line 14-14.

FIG. 16A is a cross-sectional view of the cover of FIG. 14, viewed along line 14-14, modified to include rebar.

FIG. 17 is a top perspective view of an underground enclosure according to the present disclosure.

FIG. 18 is a top perspective view of another underground enclosure according to the present disclosure

FIG. 19 is a schematic diagram of a method of making an underground enclosure of long fiber composite.

### DETAILED DESCRIPTION

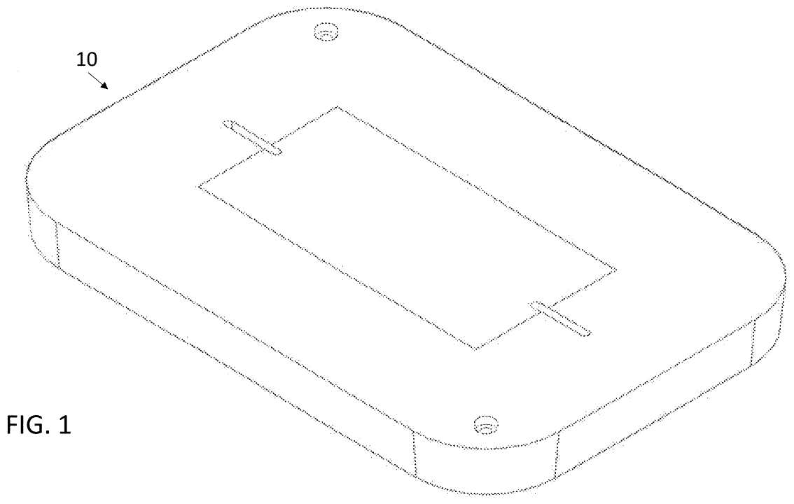

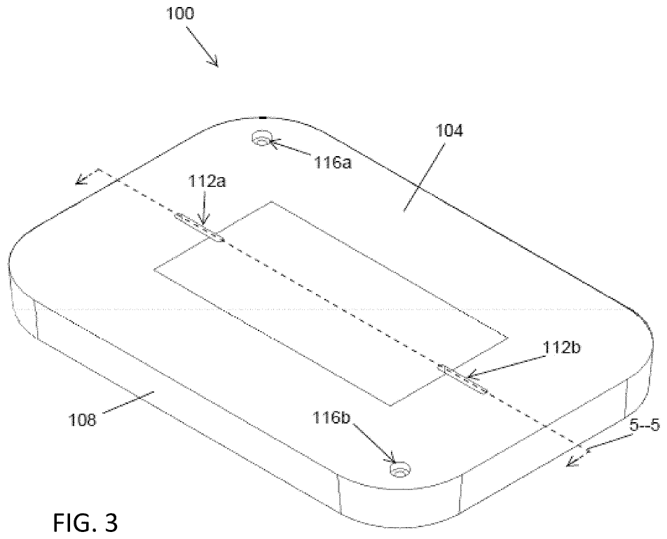

Referring to the drawings, and, in particular to FIGS. 1 and 3, exemplary embodiments of underground utility covers made with long fiber thermoplastic composite structures molded through injection molding, compression, or fiber-direct compounding and molding process are shown and referred to as reference numerals 10, 100, 300, 500, 700. Covers made with long fiber thermoplastic composite structures, for example, covers 10, 100, 300, 500, 700, are lightweight, recyclable, and relatively inexpensive. The discontinuous fiber thermoplastic material is low density, easily processed, and can have an infinite shelf life. The molding process of covers made with long fiber thermoplastic composite structures ensures that the production cost is low and offers high flexibility for the design and manufacturing of the composite structure in a single step.

The advantages of long fiber-reinforced thermoplastics (LFT) composites are high strength and stiffness, lightweight, and ease of processing through an injection or compression molding process. By using low cost ingredients for the matrix and the fibers, the LFT has the potential to be an efficient material for enclosures and covers.

The reinforcing fibers can be glass, carbon, basalt, aramid, or a combination thereof. The matrix material can be Polymers that include but not limited to polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), or a combination thereof.

The LFT in-line compounding and molding process is a new process that combines compounding chopped fibers with resin melt and molding the formed pellets into a closed mold. In-line compounding of fiber with resin eliminates the need for the additional steps of packaging and transporting long pellets and allows more design flexibility by varying the length of the chopped fibers and the fiber-to-resin ratio.

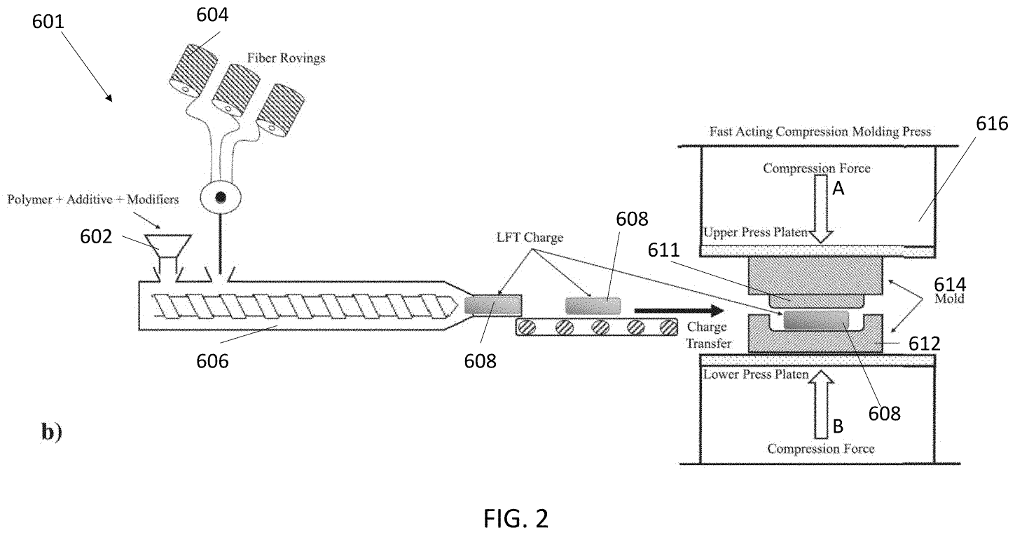

Referring to FIG. 2, an example of an LFT injection process is shown as process 601. Process 601 has the matrix material in a dosing unit 602 that is combined with additives and modifiers and mixed with fibers from fiber rovings 604 in an extruder 606 to produce a LFT charge 608. LFT charge 608 is moved between an upper press platen 611 and a lower press platen 612 of a mold 614 of a fast-acting compression molding press 616. A first compression force A is applied to move upper press platen 611 and a second compression force B is applied to lower press platen 612 moving upper press platen 611 and lower press platen 612 toward one another to contact and mold LFT charge 608 into the shape of a cover, for example, covers 10, 100, 300, 500, 700, and, then, upper press platen 611 and lower press platen 612 are moved away from one another to remove the cover, for example, cover 10, 100, 300, 500, 700.

Different designs could be achieved with the long fiber thermoplastic composite other than the designs of covers 10, 100, 300, 500, 700. The shape of the different covers can be circular, rectangular, elliptical or hexagonal.

The lightweight cover for an underground utility enclosure made with long fiber thermoplastic composite material and the method of manufacturing of the cover by process 601 are provided herein. As discussed herein, current composite materials made with sheet molded compound or Polymer concrete materials produce high VOC emissions and are non-recyclable. The LFT composite is Styrene-free, recyclable, lightweight, and relatively inexpensive to manufacture.

Referring to FIG. 3, in a second embodiment, cover 100 may include an upper surface with a pattern of bosses, with or without a lower opposite lower surface. An example of the second embodiment is in U.S. patent application Ser. No. 16/886,159, filed May 28, 2020, that is hereby incorporated by reference in its entirety.

As shown in FIG. 3, the cover 100 may include an upper surface 104 and a side surface 108 that may extend from the upper surface 104. As shown in the illustrated embodiment, the upper surface 104 may define a substantially rectangular shape. For example, the upper surface 104 may include two pairs of parallel sides and rounded corners. The side surface 108 may be a single wall that extends entirely around the perimeter of the upper surface 104. In other embodiments, the side surface 108 may extend around only a portion of the perimeter of the upper surface 104, and/or the cover 100 may include multiple side surfaces 108.

A first slot 112a and a second slot 112b may be disposed on the upper surface 104. In the illustrated embodiment, the first and second slots 112a, 112b may be formed as elongated openings and may be formed during a molding process. The first slot 112a may be aligned with the second slot 112b, and both slots 112a, 112b extend along a common axis. The first and second slots 112a, 112b have substantially the same shape. The first and second slots 112a, 112b may be disposed proximate a center of the upper surface 104, and the axis extending through the first and second slots 112a, 112b may also extend through the center of the upper surface 104. In other embodiments, the first and second slots 112a, 112b may be disposed at different positions and/or may be different shapes. In other embodiments, the first and second slots 112a, 112b may be constructed and arranged to incorporate an eyebolt or fastener as an anchor to be used for lifting. In a number of embodiments, first and second slots 112a, 112b may be formed during a molding process but capable of being widened after the molding process by shaving, grinding, cutting, or by any other process known for shaping polymers. In some cases, an eyebolt may be removably disposed in first and second slots 112a, 112b by a fastener, clips, or the like so that the eyebolt may be removed or replaced if worn or damaged. In such cases, the fastener or clips may be part of the eyebolt itself.

A first aperture 116a and a second aperture 116b may also be disposed on the upper surface 104. In the illustrated embodiment, the first and second apertures 116a, 116b may be generally circular. The first and second apertures 116a, 116b may also be disposed proximate a respective corner of the upper surface 104. In other embodiments, the first and second apertures 116a, 116b may be different shapes and/or disposed in different locations of the upper surface 104.

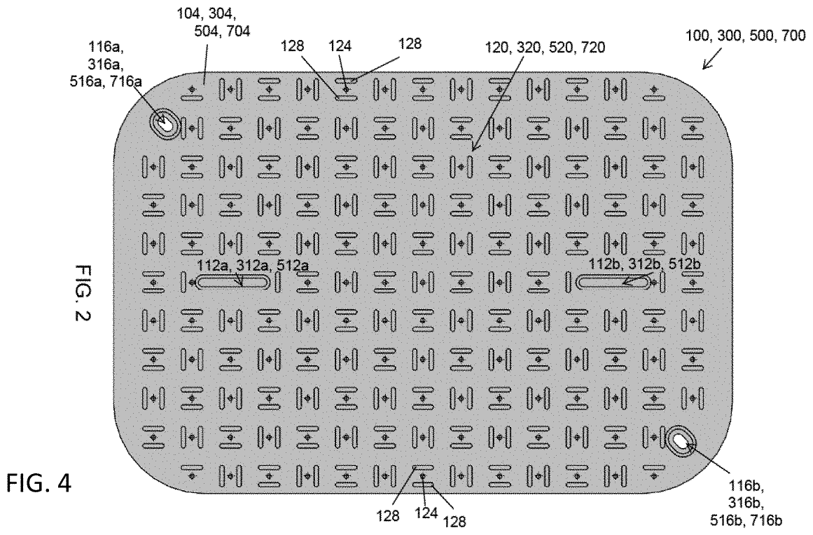

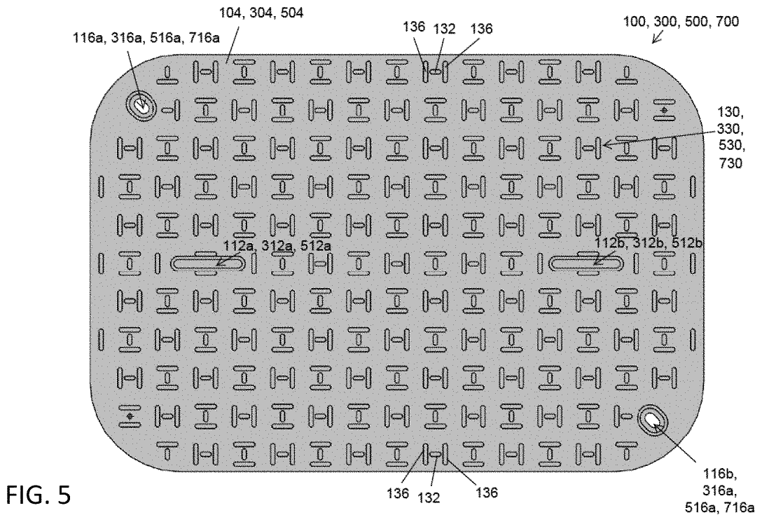

As shown in FIGS. 4 and 5, the upper surface 104 may include different patterns along at least a portion of the upper surface 104. The patterns may define raised bosses that extend from the upper surface 104. In some embodiments, the upper surface 104 may include a first or “H-Dot” pattern 120 (see e.g., FIG. 4). The H-Dot pattern may include a point bosses 124 surrounded by a pair of elongated bosses 128. In other embodiments, the upper surface 104 may include a second or “H” pattern 130 (see e.g., FIG. 5). The H pattern may include a first elongated boss 132 and a pair of second elongated raised bosses 136 disposed generally orthogonally with respect to the first elongated boss 132.

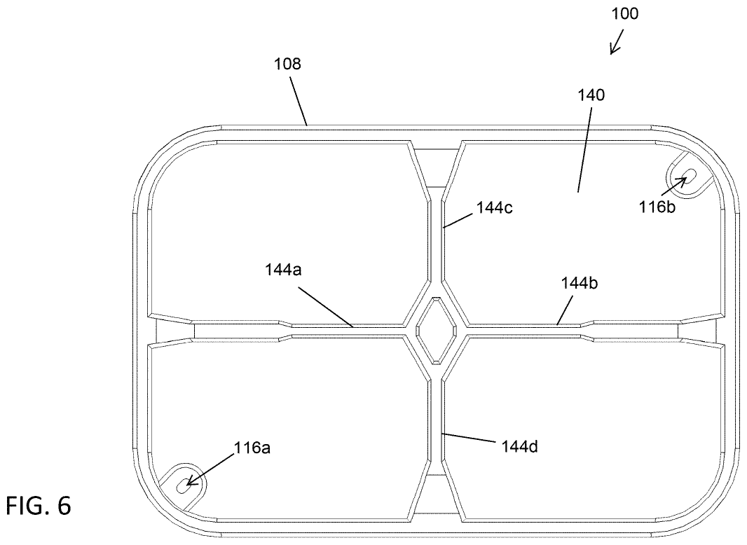

As shown in FIG. 6, the cover 100 may include a lower surface 140 that may be disposed generally opposite of the upper surface 104. The side surface 108 may extend beyond the lower surface 140 such that the lower surface 140 is recessed relative to an end of the side surface 108. Reinforcement members or ribs 144 may be coupled to the lower surface 140 and extend toward the end of the side surface 108. As shown in the illustrated embodiment, the cover 100 may include four ribs 144a-144d. In other embodiments, the cover 100 may include more or fewer ribs 144.

Each rib 144a-144d may be coupled to the side surface 108 and extends toward a center of the lower surface 140. Each rib 144a-144d may be disposed approximately orthogonally with respect to the adjacent two ribs 144a-144d. In the illustrated embodiment, the ribs 144a-144d may be integrally formed with the side surface 108. Additionally, the ribs 144a-144d may meet at approximately the center of the lower surface 140 and may be integrally formed with each other. Together, the four ribs 144a-144d may form a cross shape.

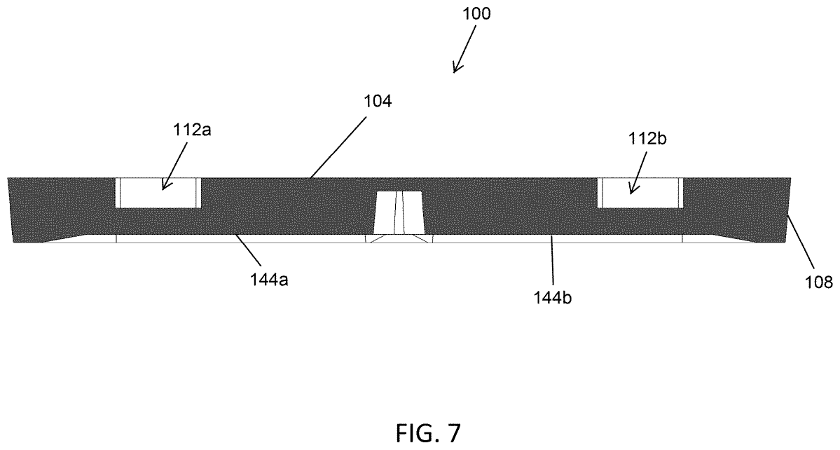

As shown in FIG. 7, the ribs 144a-144d may extend substantially along the height of the side surface 108. The first slot 112a and the second slot 112b may extend into the first rib 114a and the second rib 114b respectively, and may extend partially along the height of the ribs 144a, 144b. In the illustrated embodiment, the first slot 112a and the second slot 112b may extend substantially the same distance through the respective rib 144a, 144b. Cover 100 is made by the LFT compression molding process, for example, as shown in process 601.

In use, the cover 100 may be positioned on an enclosure (e.g., an underground utility box—not shown) in a high traffic area (e.g., a sidewalk or a roadway). Fasteners (e.g., bolts—not shown) may be inserted through each of the apertures 116a, 116b in order to couple the cover 100 to the enclosure. The cover 100 may be flush or substantially flush with the ground in order to allow pedestrians or vehicles to pass. The patterns 120, 130 may increase the coefficient of friction of the upper surface 104 and may reduce slippage across the surface 104. The ribs 144a-144d may provide the cover 100 with structural integrity and strength in order to withstand the weight of various objects (e.g., people, cars, etc.). The ribs 144a-144d may help to prevent the upper surface 104 from fracturing or collapsing, while also providing rigidity to the side surface 108 in order to limit flexion. The ribs 144a-144d may provide additional strength because of their placement through the center of the lower surface 140. Additionally, providing the first and second slots 112a, 112b in the respective first and second ribs 144a, 144b may serve to maintain the geometry and integrity of the ribs 144a-144d. This may also reduce the need for extra components since the slots 112a, 112b and the ribs 144a, 144b may be combined.

When a user wants to remove the cover 100 from the enclosure, hooks, loops, clips, or any other apparatus constructed and arranged to hold onto an eyebolt disposed in a slot of the cover 100 may be inserted into at least one of the first or second slots 112a, 112b. The apparatus constructed and arranged to hold onto an eyebolt may be lifted, and the cover 100 may be removed from the enclosure (i.e., the cover 100 no longer encloses an interior of the enclosure).

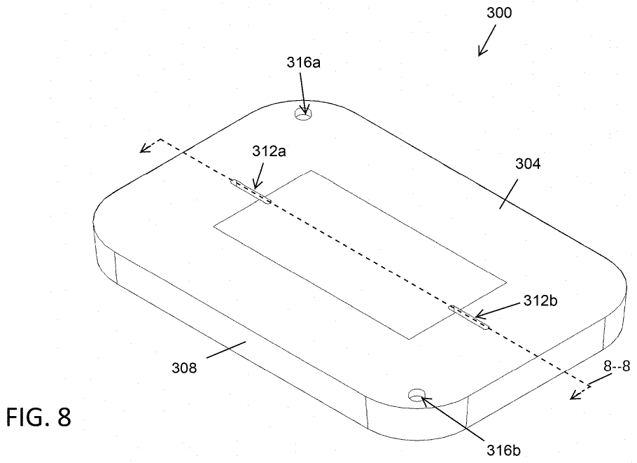

As shown in FIG. 8, the cover 300 may include an upper surface 304 and a side surface 308 that may extend from the upper surface 304. The side surface 308 may be a single wall that may extend entirely around the perimeter of the upper surface 304. A first slot 312a and a second slot 312b may be disposed on the upper surface 304. In the illustrated embodiment, the first and second slots 312a, 312b may be formed as elongated openings and may be formed during a molding process. The first slot 312a may be aligned with the second slot 312b, and both slots 312a, 312b may extend along a common axis. The first and second slots 312a, 312b may be disposed proximate a center of the upper surface 304, and the axis extending through the first and second slots 312a, 312b may also extend through the center of the upper surface 304. In other embodiments, the first and second slots 312a, 312b may be disposed at different positions and/or may be different shapes. A first aperture 316a and a second aperture 316b may also be disposed on the upper surface 304. In other embodiments, the first and second slots 312a, 312b may be constructed and arranged to incorporate an eyebolt or fastener as an anchor to be used for lifting. In a number of embodiments, first and second slots 312a, 312b may be formed during a molding process but capable of being widened after the molding process by shaving, grinding, cutting, or by any other process known for shaping polymers. In some cases, an eyebolt may be removably disposed in first and second slots 312a, 312b by a fastener, clips, or the like so that the eyebolt may be removed or replaced if worn or damaged. In such cases, the fastener or clips may be part of the eyebolt itself.

As shown in FIGS. 4 and 5, the upper surface 304 may include different patterns of texture, bosses, or recesses along at least a portion of the upper surface 304. In some embodiments, the upper surface 304 may include the H-Dot pattern 320 or bosses, recesses, or bosses and recesses (see e.g., FIG. 4). In other embodiments, the upper surface 304 may include the H pattern 330 of bosses, recesses, or bosses and recesses (see e.g., FIG. 5). The patterns 320, 330 on the upper surface 304 of the cover 300 may be substantially the same as the patterns 120, 130 on the upper surface 104 of the cover 100.

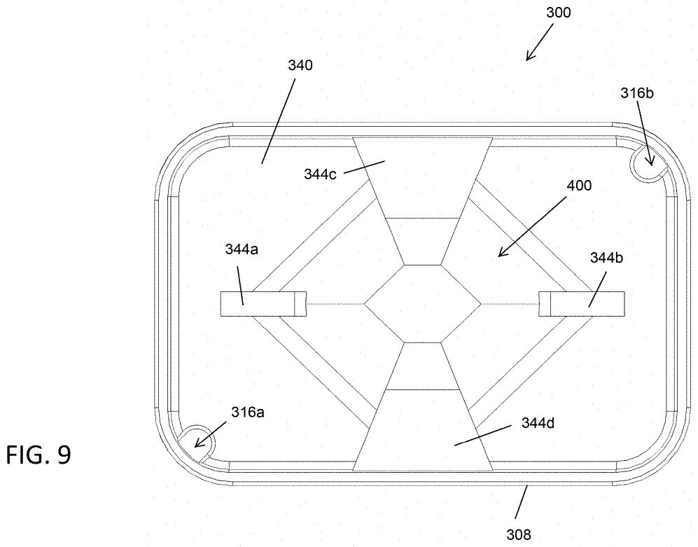

As shown in FIG. 9, the cover 300 may include a lower surface 340 disposed generally opposite of the upper surface 304. The side surface 308 may extend beyond the lower surface 340 so that the lower surface 340 is recessed relative to an end of the side surface 308. Reinforcement members or ribs 344 may be coupled to the lower surface 340 and extend toward the end of the side surface 308. As shown in the illustrated embodiment, the cover 300 may include four reinforcement members 344a-344d. As used herein “reinforcement member” may be distinguished from “rib” in that a reinforcement member may not extend between two sides of the cover 300 or form a junction with a side surface 308 of the cover 308.

Two reinforcement members 344a, 344b may be spaced apart from the side surface 308 and two reinforcement members 344c, 344d may be coupled to the side surface 308. Each reinforcement member 344a-344d may be disposed approximately orthogonally with respect to the adjacent two reinforcement members 344a-344d. As shown in the illustrated embodiment, the reinforcement members 344c, 344d may be integrally formed with the side surface 308. Additionally, the reinforcement members 344a-344d may be integrally formed with a support structure 400. The support structure 400 may extend from the lower surface 340 toward the end of the side surface 308. The support structure 400 may be disposed generally over the center of the lower surface 340 in a generally convex orientation. Each reinforcement member 344a-344d may be formed proximate an outer edge of the support structure 400. As shown in the illustrated embodiment, the support structure 400 may have a generally rectangular perimeter that may intersect the reinforcement members 344a-344d, and a hexagonal center.

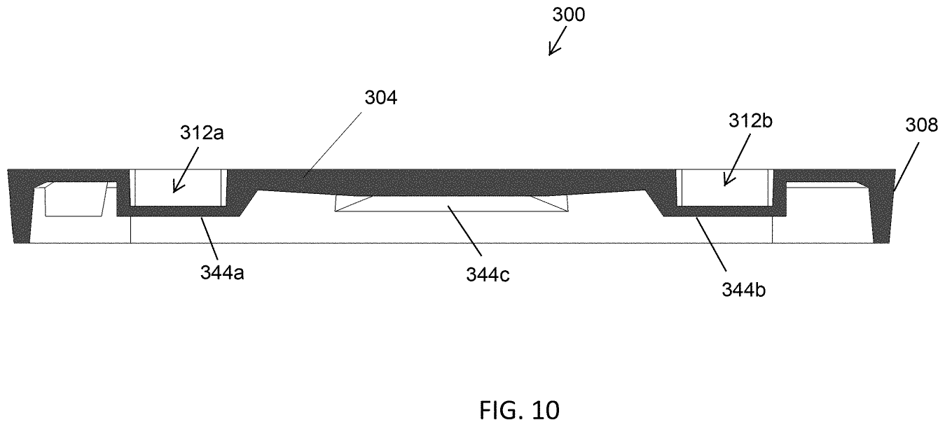

As shown in FIG. 10, the reinforcement members 344a-344d may extend partially along a height of the side surface 308, and may be spaced apart from the end of the side surface 308. It is also contemplated that the reinforcement members 344a-344d may comprise a depth or height that extends the full height of the side surface 308 or may be substantially flush with the lower surface 340. The first slot 312a and the second slot 312b may extend into the first reinforcement member 344a and the second reinforcement member 344b respectively, and may extend partially along the height of the reinforcement members 344a, 344b. As shown in the illustrated embodiment, the first slot 312a and the second slot 312b may extend substantially the same distance through the respective reinforcement member 344a, 344b. Cover 300 is made by the LFT compression molding process, for example, as shown in process 601.

In use, the cover 300 may be positioned on an enclosure (e.g., an underground utility box—not shown) in a high traffic area (e.g., a sidewalk or a roadway) in a similar manner as the cover 100. The reinforcement members 344a-344d and the support structure 400 may provide the cover 300 with structural integrity and strength in order to withstand the weight of various objects (e.g., people, cars, etc.). Together, the reinforcement members 344a-344d and the support structure 400 may help to prevent the upper surface 304 from fracturing or collapsing, while also providing rigidity to the side surface 308 in order to limit flexion. The reinforcement members 344a-344d and the support structure 400 may provide additional strength because of their placement through the center of the lower surface 340. Particularly, the placement of the support structure 400 may provide a center of gravity for the cover 300 that helps to increase the overall force the cover 300 can withstand. Additionally, providing the first and second slots 312a, 312b in the respective first and second ribs 344a, 344b may serve to maintain the geometry and integrity of the reinforcement members 344a-344d. This may also reduce the need for extra components since the slots 312a, 312b and the reinforcement members 344a, 344b are combined. The cover 300 may be removed from the enclosure in a similar manner to the cover 100.

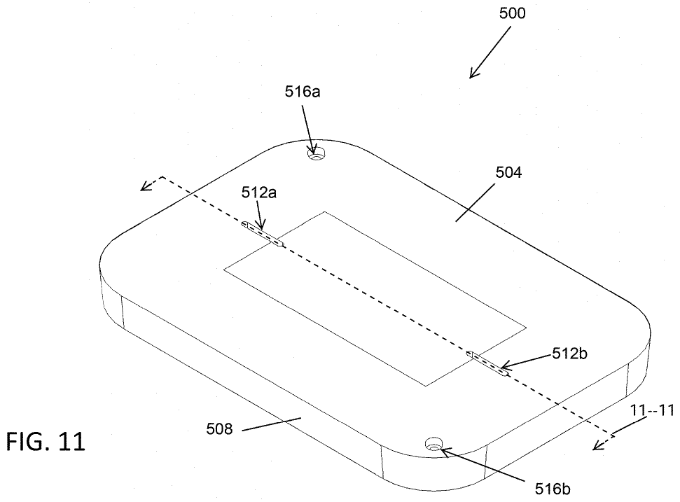

As shown in FIG. 11, the cover 500 may include an upper surface 504 and a side surface 508 that may extend from the upper surface 504. The side surface 508 may be a single wall that extends entirely around the perimeter of the upper surface 504. A first slot 512a and a second slot 512b may be disposed on the upper surface 504. In the illustrated embodiment, the first and second slots 512a, 512b may be formed as elongated openings and may be formed during a molding process. The first slot 512a may aligned with the second slot 512b, and both slots 512a, 512b may extend along a common axis. The first and second slots 512a, 512b may be disposed proximate a center of the upper surface 504, and the axis extending through the first and second slots 512a, 512b may also extend through the center of the upper surface 504. In other embodiments, the first and second slots 512a, 512b may be disposed at different positions and/or may be different shapes. A first aperture 516a and a second aperture 516b may also be disposed on the upper surface 504. In other embodiments, the first and second slots 512a, 512b may be constructed and arranged to incorporate an eyebolt or fastener as an anchor to be used for lifting. In a number of embodiments, first and second slots 512a, 512b may be formed during a molding process but capable of being widened after the molding process by shaving, grinding, cutting, or by any other process known for shaping polymers. In some cases, an eyebolt may be removably disposed in first and second slots 512a, 512b by a fastener, clips, or the like so that the eyebolt may be removed or replaced if worn or damaged. In such cases, the fastener or clips may be part of the eyebolt itself.

As shown in FIGS. 4 and 5, the upper surface 504 may include different patterns along at least a portion of the upper surface 504. In some embodiments, the upper surface 504 may include the H-Dot pattern 520 (see e.g., FIG. 4). In other embodiments, the upper surface 504 may include the H pattern 530 (see e.g., FIG. 5). The patterns 520, 530 on the upper surface 504 of the cover 500 may be substantially the same as the patterns 120, 130 on the upper surface 104 of the cover 100.

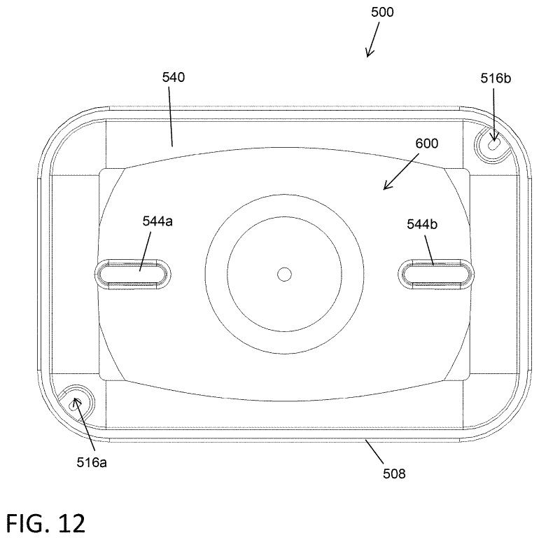

As shown in FIG. 12, the cover 500 may include a lower surface 540 disposed generally opposite of the upper surface 504. The side surface 508 may extend beyond the lower surface 540 so that the lower surface 540 is recessed relative to an end of the side surface 508. Reinforcement members or ribs 544 may be coupled to the lower surface 540 and extend toward the end of the side surface 508. In the illustrated embodiment, the cover 500 may include two reinforcement members 544a, 544b.

The reinforcement members 544a, 544b may be spaced apart from the side surface 508 and aligned with one another so that an axis extends through a center of each reinforcement member 544a, 544b. As shown in the illustrated embodiment, the reinforcement members 544a, 544b may be integrally formed with a support structure 600. The support structure 600 may also extend from the lower surface 540 toward the end of the side surface 608. The support structure 600 may be disposed generally over the center of the lower surface 640 in a generally convex orientation. The reinforcement members 544a, 544b are formed proximate an outer edge of the support structure 600. As shown in the illustrated embodiment, the support structure 600 may have a generally rounded rectangular perimeter that encompasses the ribs 544a, 544b, and a circular center. As shown, a support structure 600 comprising a circular center may comprise tiered sections. Tiers comprising a rounded rectangle center or a circular center may have different radii of curvature. The edges of a rounded rectangle center may also be disposed proximate a side surface 508.

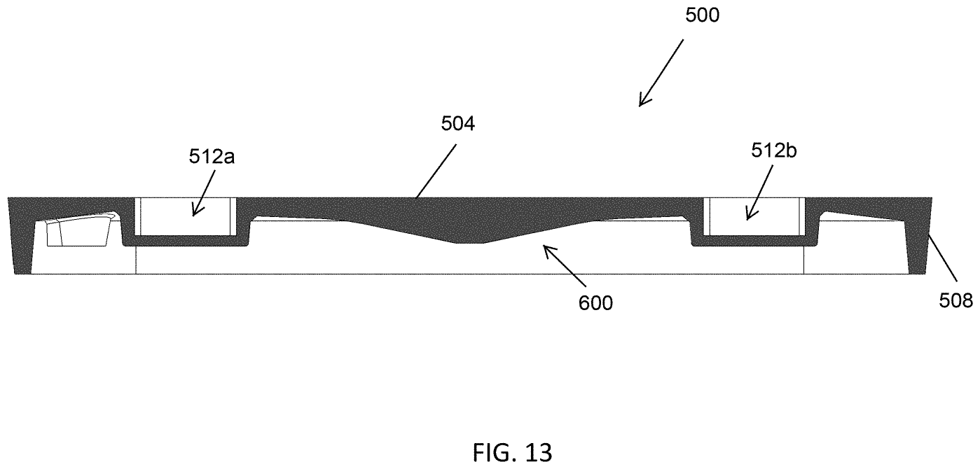

As shown in FIG. 13, the reinforcement members 544a, 544b may extend partially along a height of the side surface 508, and may be spaced apart from the end of the side surface 508. The first slot 512a and the second slot 512b may extend into the first reinforcement member 514a and the second reinforcement member 514b respectively, and may extend partially along the height of the reinforcement members 544a, 544b. It is also contemplated that the reinforcement members 544a, 544b may comprise a depth or height that extends the full height of the side surface 508 or may be substantially flush with the lower surface 540. As shown in the illustrated embodiment, the first slot 512a and the second slot 512b may extend substantially the same distance through the respective reinforcement members 544a, 544b. Cover 500 is made by the LFT compression molding process, for example, as shown in process 601.

In use, the cover 500 may be positioned on an enclosure (e.g., an underground utility box—not shown) in a high traffic area (e.g., a sidewalk or a roadway) in a similar manner as the cover 100. The support structure 600 may provide the cover 500 with structural integrity and strength in order to withstand the weight of various objects (e.g., people, cars, etc.). The support structure 600 may help to prevent the upper surface 504 from fracturing or collapsing. The support structure 600 may provide additional strength because of its placement near the center of the lower surface 640. Particularly, the placement of the support structure 600 may provide a center of gravity for the cover 500 that may help to increase the overall force the cover 500 can withstand. Additionally, providing the first and second slots 512a, 512b in the respective first and second reinforcement member 544a, 544b may serve to maintain the geometry and integrity of the reinforcement members 544a, 544b. This may also reduce the need for extra components since the slots 512a, 512b and the reinforcement members 544a, 544b may be combined. The cover 500 may be removed from the enclosure in a similar manner to the cover 100.

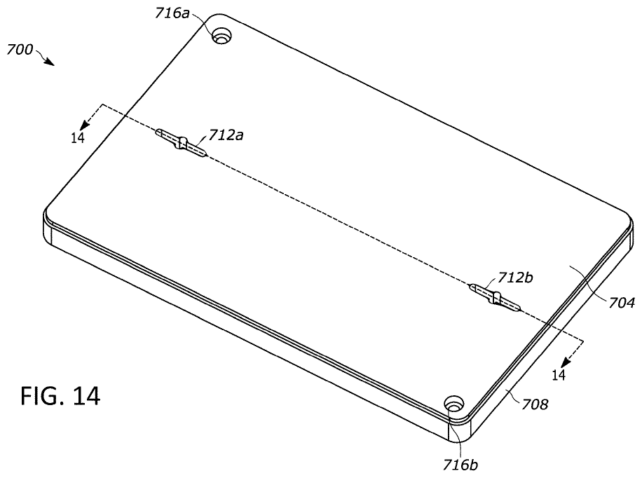

As shown in FIG. 14, the cover 700 includes an upper surface 704 and a side surface 708 that may extend from the upper surface 704. The side surface 708 may be a single wall that extends entirely around the perimeter of the upper surface 704. It is also contemplated that side surface 708 may extend only partially around the perimeter of the upper surface 704. A first slot 712a and a second slot 712b may be disposed on the upper surface 704. In the illustrated embodiment, the first and second slots 712a, 712b may be formed as elongated openings and may be formed during a molding process. The first slot 712a may be aligned with the second slot 712b, and both slots 712a, 712b may extend along a common axis. The first and second slots 712a, 712b may be disposed proximate a center of the upper surface 704, and the axis extending through the first and second slots 712a, 712b may also extend through the center of the upper surface 704. In other embodiments, the first and second slots 712a, 712b may be disposed at different positions and/or may be different shapes. A first aperture 716a and a second aperture 716b may also be disposed on the upper surface 704. In other embodiments, the first and second slots 712a, 712b may be constructed and arranged to incorporate an eyebolt or fastener as an anchor to be used for lifting. In a number of embodiments, first and second slots 712a, 712b may be formed during a molding process but capable of being widened after the molding process by shaving, grinding, cutting, or by any other process known for shaping polymers. In some cases, an eyebolt may be removably disposed in first and second slots 712a, 712b by a fastener, clips, or the like so that the eyebolt may be removed or replaced if worn or damaged. In such cases, the fastener or clips may be part of the eyebolt itself.

As shown in FIGS. 4 and 5, the upper surface 704 may include different patterns along at least a portion of the upper surface 704. In some embodiments, the upper surface 704 may include a H-Dot pattern 720 of recesses, bosses, or recesses and bosses (see e.g., FIG. 4). In other embodiments, the upper surface 704 may include a H pattern 730 of recesses, bosses, or recesses and bosses (see e.g., FIG. 5). Additionally, the upper surface 704 of the cover may include only a textured surface or a flat upper surface 704 and no pattern.

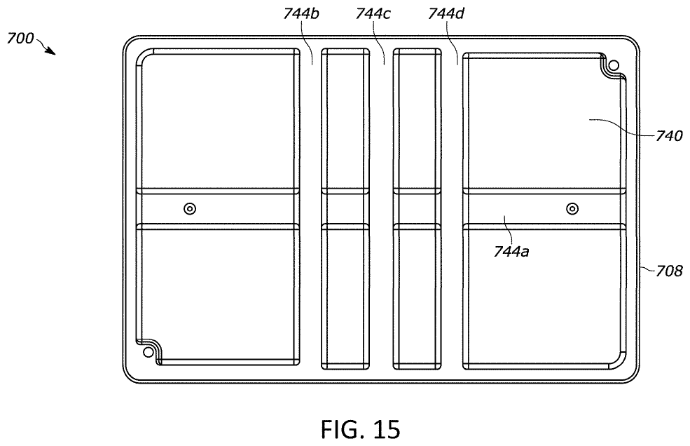

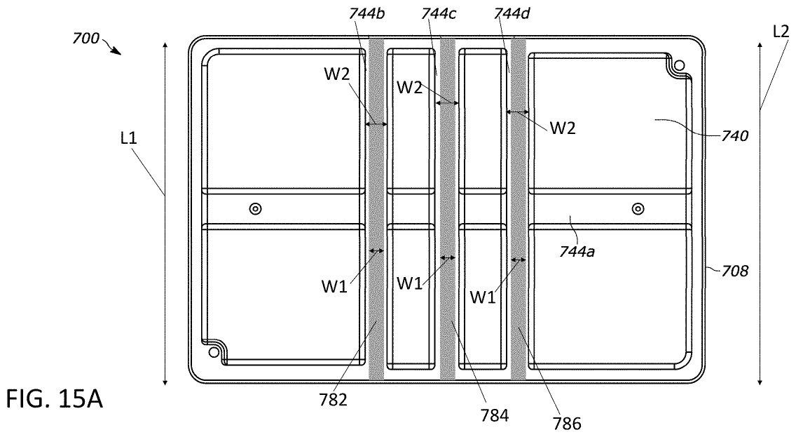

As shown in FIG. 15, the cover 700 may include a lower surface 740 disposed generally opposite of the upper surface 704. The side surface 708 may extend beyond the lower surface 740 so that the lower surface 740 is recessed relative to an end of the side surface 708. Reinforcement members or ribs 744a, 744b, 744c, 744d may be coupled to the lower surface 740 and extend between the ends of the side surface 708. As shown in the illustrated embodiment, the cover 700 may include four ribs 744a, 744b, 744c, and 744d.

The rib 744a may underlie an axis running longitudinally across the upper surface 704 and through first and second slots 712a, 712b. The ribs 744b, 744c, and 744d may lie orthogonal to the rib 744a with rib 744c evenly bisecting the cover 700 in the lateral direction with ribs 744b, 744c, and 744d equidistantly spaced along rib 744a in the longitudinal direction. In other embodiments, ribs 744b, 744c, and 744d may not be equidistantly spaced along rib 744a in the longitudinal direction. In still other embodiments, rib 744a may not bisect the lid in the longitudinal direction.

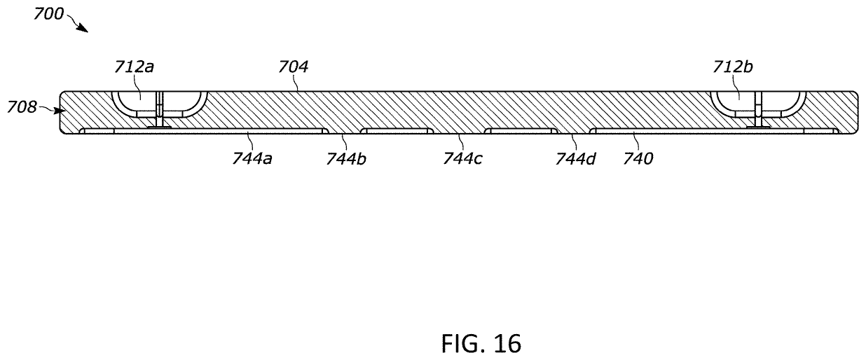

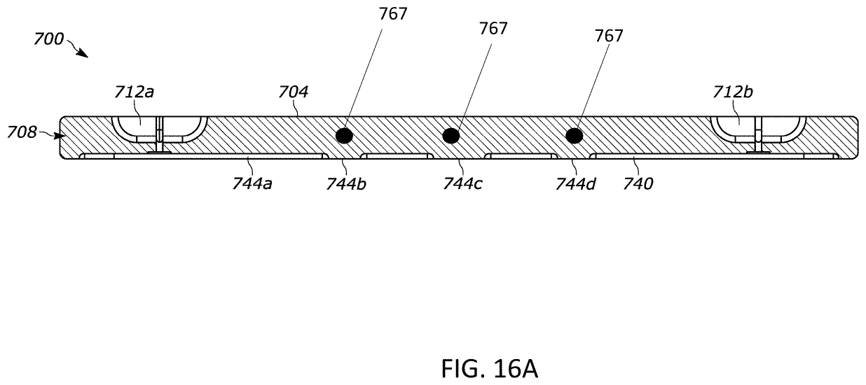

As shown in FIG. 16, the ribs 744a, 744b, 744c, and 744d may be generally in the shape of an elongated cube but may also be of an elongated rhomboid, pyramid, or hemisphere shape. It is also contemplated that at least one of the ribs 744a, 744b, 744c, and 744d may be generally flat or may take other shapes. It is further contemplated that the ribs may each be of different depths. As non-limiting example, a flat rib may be substantially flush with lower surface 740. As another non-limiting example, a flat rib's height may extend from the lower surface 740 such that the rib 744a, 744b, 744c, or 744d height extends at least partially along a height of the side surface 708. As yet another non-limiting example, a flat rib's height may extend from the lower surface 740 such that the rib 744a, 744b, 744c, or 744d height extends along the whole height of the side surface 708. As still another non-limiting example a flat rib's height may extend from the lower surface 740 such that the rib 744a, 744b, 744c, and 744d height may cause the rib 744a, 744b, 744c, or 744d to extend beyond the height of the side surface 708. In some embodiments, the ribs 744a, 7ffb, 744c, or 744d may comprise different heights, depths, or slopes. In some embodiments, ribs 744a, 744b, 744c, and 744d may be in the shape of arcs. In some such embodiments, the arc of a rib may reach its apex at the center of the rib in that the rib material extending the farthest from the lower surface 740 of the cover 700 marks the apex of the arc. In some such cases, the portion of arced ribs abutting side surface 708 may be substantially flush with lower surface 740, may extend at least partially along a height of the side surface 708, may extend along the whole height of the side surface 708, or may extend beyond the height of the side surface 708. In other embodiments, the arc of a rib may reach its apex at the center of the rib in that the rib material extending the least from the lower surface 740 of the cover 700 marks the apex of the arc. In some such cases, the portion of arced ribs abutting side surface 708 may extend along the whole height of the side surface 708, may be substantially flush with lower surface 740, may extend at least partially along a height of the side surface, or may extend beyond the height of the side surface 708. Cover 700 is made by the LFT compression molding process, for example, as shown in process 601.

In use, the cover 700 may be positioned on an enclosure (e.g., a underground utility box—not shown) in a high traffic area (e.g., a sidewalk or a roadway) in a similar manner as the cover 700. The ribs 744a, 744b, 744c, and 744d may provide the cover 700 with structural integrity and strength in order to withstand the weight of various objects (e.g., people, cars, etc.). The ribs 744a, 744b, 744c, and 744d may help to prevent the upper surface 704 from fracturing or collapsing. The ribs 744a, 744b, 744c, and 744d may provide additional strength because of their placement through the center of the lower surface 740. Particularly, the placement of the ribs 744a, 744b, 744c, and 744d may provide a center of gravity for the cover 700 that may help to increase the overall force the cover 700 can withstand. Additionally, providing the first and second slots 712a, 712b in the rib 744a may serve to maintain the geometry and integrity of the rib 744a. This also reduces the need for extra components since the slots 712a, 712b and the rib 744a may be combined. The cover 700 may be removed from the enclosure in a similar manner to the cover 500.

More embodiments of covers could possibly be made with the aforementioned materials and production methods. All embodiments may further include a first slot and a second slot each disposed on the upper surface. The first slot may extend into the first rib. A second rib may be coupled to the lower surface and may be aligned with the first rib. The second slot may extend into the second rib. Additionally, the cover may be configured to be lifted by the first slot and the second slot.

A nonlimiting example of a cover made with long fiber thermoplastic composite structures of the present disclosure, for example, covers 10, 100, 300, 500, 700, can be made of materials that include 35 percent to 50 percent fiberglass reinforcing fibers and 50 percent to 65 percent PP polymer.

Another nonlimiting example of a cover made with long fiber thermoplastic composite structures, for example, covers 10, 100, 300, 500, 700, can include additives, modifiers and/or release agents, for example, thermal stabilizer, ultraviolet (UV) additive, bonding agent and/or any combination thereof. The additives, modifiers and/or release agents can be 1 percent to 7 percent of the materials used for the cover, and preferably modifiers and/or release agents can be 1 percent to 3 percent of the materials used for the cover.

Although not required, a cover made with long fiber thermoplastic composite structures, for example, covers 10, 100, 300, 500, 700, can also include tape, for example, unidirectional polymer composite tapes. The tape reinforces the LFT composites of the cover, for example, covers 10, 100, 300, 500, 700. The tape can be made of a material that is about 60 percent fiberglass and 40 percent PP. The tape can be made of a material that is an aramid fiber, basalt fiber, carbon fiber, or other material that would provide reinforcement. The tape can have a thickness of 3 millimeters (mm) to 8 mm. The tape can have a length that is 5 percent of the length of the cover up to 100 percent the length of the cover and a width that is 5 percent of the width of the cover up to 100 percent the width of the cover. A nonlimiting example is shown in FIG. 15A, cover 700 can be made with long fiber thermoplastic composite structures made of a material that has 35 percent to 50 percent fiberglass reinforcing fibers and 50 percent to 65 percent PP polymer and also has a first segment of tape 782 that extends along rib 744b on lower surface 740, a second segment of tape 784 that extends along rib 744c on lower surface 740, and a third segment of tape 786 that extends along rib 744d on lower surface 740. First segment of tape 782, second segment of tape 784, and third segment of tape 786 can have a width W1 that is 5 percent of a width W2 of ribs 744b, 744c, and 744d up to 100 percent width W2 of ribs 744b, 744c, and 744d and first segment of tape 782, second segment of tape 784, and third segment of tape 786 can have a length L1 that is 5 percent of a length L2 of ribs 744b, 744c, and 744d up to 100 percent length L2 of ribs 744b, 744c, and 744d. First segment of tape 782, second segment of tape 784, and third segment of tape 786 have a thickness of 3 mm to 8 mm.

Another non-limiting example includes a cover made with long fiber thermoplastic composite structure of, for example, cover 700 of FIG. 15A, that has Fiberglass and Polypropylene with (by weight) 45% Fiberglass, 2% bonding agent, 2% UV additive, 2% thermal stabilizer, and 49% Polypropylene. The cover can be reinforced with three longitudinal 6 mm thick fiberglass tapes similar to first segment of tape 782, second segment of tape 784, and third segment of tape 786 shown in FIG. 15A.

Alternatively, the cover made with long fiber thermoplastic composite structures, for example, covers 10, 100, 300, 500, 700, can be reinforced using any material with high strength. Materials with high strength can include metal rebar, for example, steel rebar, balsa wood, polymer composite rebar, and any combination thereof. A nonlimiting example is shown in FIG. 16A, cover 700 can be made with long fiber thermoplastic composite structures made of a material that has 35 percent to 50 percent fiberglass reinforcing fibers and 50 percent to 65 percent PP polymer and also has rebar 767. Rebar 767 is shown as cylindrical in shape, however, rebar 767 can be other shapes.

A cover made with long fiber thermoplastic composite structures of the present disclosure, for example, covers 10, 100, 300, 500, 700, can be made of materials such as long fiber reinforced structural thermoplastics; long glass fiber reinforced engineering resins with enhanced mechanical properties; structural injection molding composites; composites that are made from polyketone; materials made using post-consumer recycled (PCR) nylon 6 resin, post-industrial recycled (PIR) nylon 66 resin, or PIR thermoplastic polyurethane (TPU) resin; PA to PEEK; long glass fiber reinforced polypropylene composites that utilize carbon, glass, or specialty fibers in a broad range of thermoplastic polymers, polymer resins and fiber reinforcement combinations including polypropylene; various nylon (polyamide) formulations; engineered thermoplastic polyurethane resins combined with carbon and/or glass fibers, as well as functional performance enhancing additives; long carbon fiber reinforced thermoplastics; combination of long carbon and long glass fiber together in a unified material; and/or long fiber reinforced nylons (polyamides).

LFT composite structures can have challenges, for example, LFT composite structures can be undesirably costly. The present disclosure addresses this concern by using an LFT in-line compounding and molding process of process 601. LFT composite structures can have further challenges, for example, LFT composite structures can have undesirably low strength. The present disclosure addresses this concern by using the materials and/or use of reinforcing materials, for example, tapes and/or rebar, described herein for the cover, for example, covers 10, 100, 300, 500, 700 that can withstand 22500 pounds-force to 50000 pounds-force.

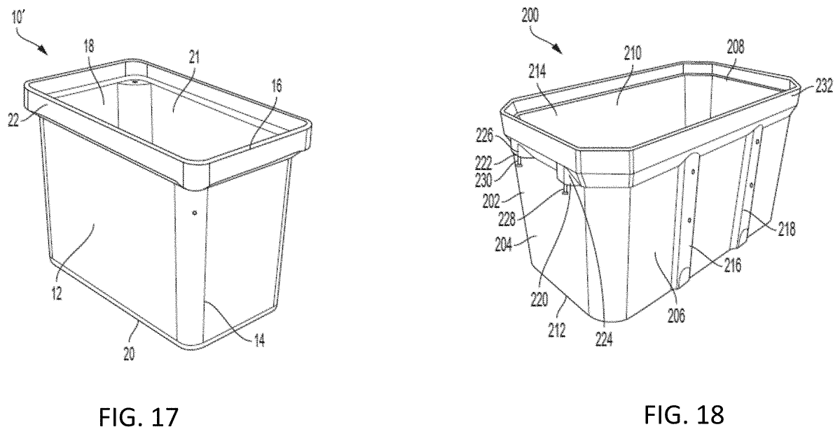

Referring to the drawings, and, in particular to FIG. 17, an exemplary embodiment of an underground enclosure is shown and referred to as reference numeral 10′ (“enclosure 10′”). Enclosure 10′ is made with a long fiber thermoplastic composite structure molded through injection molding, compression, or fiber-direct compounding and molding process. Advantageously, an enclosure made with a long fiber thermoplastic composite structure, for example, enclosure 10′, is a new box that is lightweight, recyclable, and relatively inexpensive. The discontinuous fiber thermoplastic material of, for example, enclosure 10′, is low density, easily processed, and has an infinite shelf life. The molding process of, for example, enclosure 10′, ensures that the production cost is low and offers high flexibility for the design and manufacturing of the composite structure in a single step.

The advantages of long fiber-reinforced thermoplastic (“LFT”) composites are high strength and stiffness, lightweight, and ease of processing through an injection or compression molding process. By using low-cost ingredients for the matrix and the fibers, the LFT has the potential to be an efficient material for utility underground enclosures such as enclosure 10′. The reinforcing fibers can be glass, carbon, basalt, aramid, or a combination thereof. The matrix material can be Polymers that include but not limited to polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), or a combination thereof.

Direct long fiber thermoplastic (“D-LFT”) injection process is a new process that combines compounding the chopped fibers with the resin melt and injecting the formed mixture into a closed mold. In-line compounding of the polymer-reinforced fibers eliminates the need for the additional steps of packaging and transporting long pellets and allows more design flexibility by varying the length of the chopped fibers.

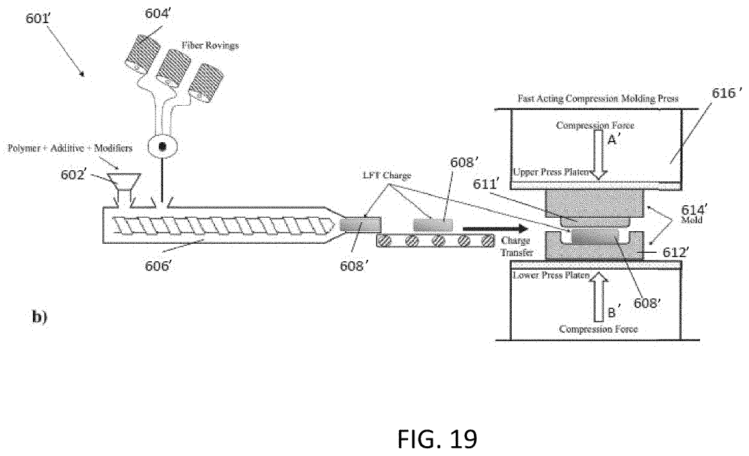

Referring to FIG. 19, an example of an LFT injection process is shown as process 601′. Process 601′ has the matrix material in a dosing unit 602′ that is combined with additives and modifiers and mixed with fibers from fiber rovings 604′ in an extruder 606′ to produce an LFT charge 608′. LFT charge 608′ is moved between an upper press platen 611′ and a lower press platen 612′ of a mold 614′ of a fast-acting compression molding press 616′. A first compression force A′ is applied to move upper press platen 611′ and a second compression force B′ is applied to lower press platen 612′ moving upper press platen 611′ and lower press platen 612′ toward one another to contact and mold LFT charge 608′ into the shape of an underground enclosure, for example, enclosure 10′, and, then, upper press platen 611′ and lower press platen 612′ are moved away from one another to remove the underground enclosure, for example, enclosure 10′.

In one embodiment shown in FIG. 17, the underground utility enclosure may include four side walls 12, 14, 16, 18 and a lower surface or wall 20 as shown for enclosure 10′. A ridge 22 extends outward and upward from each of side walls 12, 14, 16, 18. Side walls 12, 14, 16, 18 and lower surface or wall 20 surround an interior volume 21. Enclosure 10′ can have a cover that closes an opening formed by side walls 12, 14, 16, 18.

Referring to FIG. 18, a second exemplary embodiment of the underground enclosure is shown and referred to as reference numeral 200 (“enclosure 200”). Enclosure 200 may include a body 202 having four side walls 204, 206, 208, 210 with or without a pattern of bosses, and with or without a lower opposite lower surface or wall 212. Side walls 204, 206, 208, 210 and lower surface or wall 212 surround an interior volume 214. Enclosure 200 is a ribbed utility enclosure design having ribs 216, 218 formed on side wall 206 and the same ribs on sidewall 210. Side wall 204 has openings 220, 222. Side wall 204 has a shield 224 above opening 220 and a shield 226 above opening 222. Side wall 208 has a shield above an opening that is similar to opening 220 and shield 224 of side wall 204 and side wall 208 also has a shield above an opening that is similar to shield 226 above opening 222 of side wall 204. Openings 220, 222 each receive one of cover bolts 228, 230. The openings through side wall 208 also each receive one of other cover bolts similar to cover bolts 228, 230. A ridge 232 extends outward and upward from each of side walls 204, 206, 208, 210. Enclosure 200 can have a cover that closes an opening formed by side walls 204, 206, 208, 210, and cover bolts 228, 230 can pass through side wall 204 and the cover and the other cover bolts can pass through side wall 208 and the cover to connect the cover and enclosure 200.

Underground enclosures, for example, enclosures 10, 200, made with the long fiber thermoplastic composite materials and the aforementioned molding processes, for example, process 601′, can also include the ability to lock the cover to the underground enclosure. Underground enclosures, for example, enclosures 10′, 200, made with the long fiber thermoplastic composite materials and the aforementioned molding processes, for example, process 601′, can include mouseholes and knockouts. Underground enclosures, for example, enclosures 10′, 200, made with the long fiber thermoplastic composite materials and the aforementioned molding processes, for example, process 601′, can also include racks, for example, cable, connector, and splice racks.

Different designs can be achieved with the long fiber thermoplastic composite materials and the aforementioned molding processes, for example, process 601′, that were not possible with traditional utility manholes or underground enclosures that are made of polymer concrete, concrete, cast-iron, or steel. These different shapes are needed because of different industry applications. The shape of the underground enclosures formed by the long fiber thermoplastic composite materials and the aforementioned molding processes, for example, process 601′, can be circular, rectangular, elliptical, or hexagonal, for example, rectangular underground enclosures 10′, 200. The walls of the enclosures formed by the long fiber thermoplastic composite materials and the aforementioned molding processes, for example, process 601′, can be straight or ribbed to support the loading. The ribs can be anywhere on the side walls and/or lower surfaces. The enclosures formed by the long fiber thermoplastic composite materials and the aforementioned molding processes, for example, process 601′, can also have an open bottom for water drainage. These openings can be anywhere on the side walls and/or lower surfaces. The underground enclosure formed by the long fiber thermoplastic composite materials and the aforementioned molding processes, for example, process 601′, can be used with covers, for example, a cover that closes an opening formed by side walls 204, 206, 208, 210 of underground enclosure 200 or an opening formed by side walls 12, 14, 16, 18 of enclosure 10′.

Accordingly, the enclosures formed by the long fiber thermoplastic composite materials and the aforementioned molding processes, for example, process 601′, are underground enclosures that are used to enclose cables, WiFi cables, water lines, electrical lines, gas piping, and other electrical equipment. Advantageously, the underground enclosures formed by the long fiber thermoplastic composite materials and the aforementioned molding processes, for example, process 601′, satisfy the structural requirements while decreasing weight by up to 90% over traditional utility manholes or underground enclosures that are made of polymer concrete, concrete, cast-iron, or steel. Other advantages of the underground enclosures formed by the long fiber thermoplastic composite materials and the aforementioned molding processes, for example, process 601′, include faster paced production over traditional utility manholes or underground enclosures that are made of polymer concrete, concrete, cast-iron, or steel. In addition, as discussed herein, the enclosures formed by the long fiber thermoplastic composite materials and the aforementioned molding processes, for example, process 601′, use materials that are recyclable and do not cause high VOC emissions unlike polymer concrete. The enclosures formed by the long fiber thermoplastic composite materials and the aforementioned molding processes, for example, process 601′, preferably use materials that are polymers or thermoplastics and not thermoset materials.

The underground enclosures formed by the long fiber thermoplastic composite materials and the aforementioned molding processes, for example, process 601′, can use materials that are separate components that are then combined while forming the finished product of the enclosure, for example, enclosure 10′, 200. Advantageously, this allows use of non-specialized, non-commodity materials that are not pre-compounded. Materials that are not pre-compounded can also allow for use of nonproprietary materials that are cheaper materials. However, the long fiber thermoplastic composite materials and the aforementioned molding processes, for example, process 601′, can also alternatively use pre-compounded materials. Traditional utility manholes or underground enclosures that are made of polymer concrete are formed in open molding where chemicals can undesirably fly through the air; whereas, the enclosures formed by the long fiber thermoplastic composite materials and the aforementioned molding processes, for example, process 601′, can use closed molding so that workers are not exposed to harmful substances. Further, the enclosures formed by the long fiber thermoplastic composite materials and the aforementioned molding processes, for example, process 601′, can be formed by a more automated process so that desirably less people are touching parts. The enclosures formed by the long fiber thermoplastic composite materials and the aforementioned molding processes, for example, process 601′, can be cost competitive with enclosures made of polymer concrete.

It should also be noted that the terms “first”, “second”, “third”, “upper”, “lower”, and the like may be used herein to modify various elements. These modifiers do not imply a spatial, sequential, or hierarchical order to the modified elements unless specifically stated.

It should also be noted that the term “long fiber” could mean fiber with different lengths. Short fiber composites could also be included within this patent.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

### PARTS LIST

| | | |
|---|---|---|
| cover 10 | cover 500 | H-Dot pattern 720 |
| cover 100 | upper surface 504 | H pattern 730 |
| upper surface 104 | side surface 508 | lower surface 740 |
| side surface 108 | first slot 512a | reinforcement members or |
| first slot 112a | second slot 512b | ribs 744a, 744b, 744c, 744d |
| second slot 112b | first aperture 516a | underground enclosure 10″ |
| first aperture 116a | second aperture 516b | four side walls 12, 14, 16, 18 |
| second aperture 116b | H-Dot pattern 520 | lower surface or wall 20 |
| “H-Dot” pattern 120 | H pattern 530 | interior volume 21 |
| point bosses 124 | lower surface 540 | ridge 22 |
| pair of elongated bosses 128 | two reinforcement | underground enclosure 200 |
| “H” pattern 130 | members 544a, 544b | body 202 |
| first elongated boss 132 | support structure 600 | four side walls 204, 206, 208, |
| pair of second elongated | process 601 | 210 |
| raised bosses 136 | dosing unit 602 | lower surface or wall 212 |
| lower surface 140 | fiber rovings 604 | interior volume 214 |
| four ribs 144a-144d | extruder 606 | ribs 216, 218 |
| cover 300 | LFT charge 608 | openings 220, 222 |
| upper surface 304 | upper press platen 611 | shield 224 |
| side surface 308 | lower press platen 612 | shield 226 |
| first slot 312a | mold 614 | cover bolts 228, 230 |
| second slot 312b | fast acting compression | ridge 232 |
| first aperture 316a | molding press 616 | process 601′ |
| second aperture 316b | cover 700 | dosing unit 602′ |
| H-Dot pattern 320 | upper surface 704 | fiber rovings 604′ |
| H pattern 330 | side surface 708 | extruder 606′ |
| lower surface 340 | first slot 712a | LFT charge 608′ |
| four reinforcement members | second slot 712b | upper press platen 611′ |
| 344a-344d | first aperture 716a | lower press platen 612′ |
| support structure 400 | second aperture 716b | mold 614′ |

What is claimed is:

1. A lightweight utility cover comprising:
an upper surface formed of a long fiber reinforced thermoplastic material.

2. The utility cover of claim 1, wherein the long fiber reinforced thermoplastic material has a plurality of reinforcing fibers selected from the group consisting of glass, carbon, basalt, aramid, and a combination thereof.

3. The utility cover of claim 1, wherein the long fiber reinforced thermoplastic material has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

4. The utility cover of claim 1, wherein the upper surface is formed by a first face sheet, and further comprising reinforcing ribs connected to the first face sheet.

5. The utility cover of claim 4, wherein the first face sheet is a flat planar shape having a first length, first width and a first thickness.

6. The utility cover of claim 1, wherein the utility cover has a lower surface that is disposed generally opposite of the upper surface, and further comprising one or more reinforcement members coupled to the lower surface.

7. The utility cover of claim 6, further comprising unidirectional polymer composite tape connected to the one or more reinforcement members coupled to the lower surface.

8. The utility cover of claim 7, further comprising a first slot and a second slot disposed on the upper surface, wherein the first slot extends into a first reinforcement member of the one or more reinforcement members and the second slot extends into a second reinforcement member of the one or more reinforcement members aligned with the first reinforcement member, and wherein the utility cover is configured to be lifted by the first slot and the second slot.

9. A method of making a utility cover comprising:
Long Fiber thermoplastic (LFT) injection and/or compression molding an upper surface of the utility cover.

10. The method of claim 9, wherein the LFT injection and/or compression molding step forms a long fiber reinforced thermoplastic material that has a plurality of reinforcing fibers selected from the group consisting of glass, carbon, basalt, aramid, and a combination thereof.

11. The method of claim 9, wherein the long fiber reinforced thermoplastic material has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

12. The method of claim 9, wherein the LFT injection and/or compression molding step further comprises LFT injection molding of a first slot and a second slot on the upper surface and a lower surface being opposite the upper surface and a first reinforcement member coupled to the lower surface, wherein the first slot extends into the first reinforcement member, wherein the lower surface is coupled to a second reinforcement member that is aligned with the first reinforcement member, wherein the second slot extends into the second reinforcement member, and wherein the cover is configured to be lifted by the first slot and the second slot.

13. An underground enclosure comprising:
a side wall formed of a long fiber reinforced thermoplastic material.

14. The underground enclosure of claim 13, wherein the long fiber reinforced thermoplastic material has a plurality of reinforcing fibers selected from the group consisting of glass, carbon, basalt, aramid, and a combination thereof.

15. The underground enclosure of claim 13, wherein the long fiber reinforced thermoplastic material has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.

16. The underground enclosure of claim 13, wherein the side wall is molded through a process selected from the group consisting of injection molding, compression, and fiber-direct compounding and molding process.

17. The underground enclosure of claim 13, wherein the long fiber reinforced thermoplastic material combines chopped fibers with a resin melt to form a compounded mixture to inject the compounded mixture into a closed mold.

18. A method of making an underground enclosure comprising:
Long Fiber thermoplastic (LFT) injection and/or compression molding a side wall of the underground enclosure.

19. The method of claim 18, wherein the LFT injection and/or compression molding step forms a long fiber reinforced thermoplastic material that has a plurality of reinforcing fibers selected from the group consisting of glass, carbon, basalt, aramid, and a combination thereof.

20. The method of claim 19, wherein the long fiber reinforced thermoplastic material has a matrix material selected from the group consisting of polypropylene (“PP”), polyethylene (“PE”), polyethylene terephthalate (“PET”), thermoplastic polyurethane (“TPU”), nylon 6 (“PA6”), nylon 66 (“PA66”), polyoxymethylene (“POM”), polyether ether ketone (“PEEK”), polyaryletherketone (“PAEK”), polyphenylene sulfide (“PPS”), and a combination thereof.
